(19) United States
(12) Patent Application Publication
(10) Pub. No.: US 2019/0066398 A1
(43) Pub. Date: Feb. 28, 2019

(54) METHOD AND APPARATUS FOR AUTOMATED MAINTENANCE SCHEDULING OF AN AUTONOMOUS VEHICLE

(71) Applicant: GM GLOBAL TECHNOLOGY OPERATIONS LLC, Detroit, MI (US)

(72) Inventors: Chaitanya Sankavaram, Sterling Heights, MI (US); Steven W. Holland, Saint Clair, MI (US); Shiming Duan, Ann Arbor, MI (US); Azeem Sarwar, Rochester Hills, MI (US); Yao Hu, Sterling Heights, MI (US); Paul E. Krajewski, Troy, MI (US); Yilu Zhang, Northville, MI (US)

(73) Assignee: GM GLOBAL TECHNOLOGY OPERATIONS LLC, Detroit, MI (US)

(21) Appl. No.: 15/688,422

(22) Filed: Aug. 28, 2017

(51) Int. Cl. G07C 5/00; G06Q 50/30; G07C 5/08

(52) U.S. Cl. CPC G07C 5/006; G07C 5/085; G06Q 50/30

(57) ABSTRACT

A method and associated device for automated maintenance scheduling for an autonomous vehicle includes monitoring a state of health (SOH) of an on-vehicle subsystem and monitoring an appointment log associated with a vehicle operator. Upon detecting a change in the SOH of the on-vehicle subsystem, the method includes communicating with a service center to determine a recommended maintenance action associated with the change in the SOH of the on-vehicle subsystem and to determine a proposed service appointment for the autonomous vehicle to effect the recommended maintenance action. The proposed service appointment is coordinated with the appointment log, and verified with the vehicle operator. A service appointment is scheduled based upon the proposed service appointment when verified by the vehicle operator. The appointment log is updated to include the service appointment.

### INTRODUCTION

Autonomous vehicles can include on-board monitoring systems to detect occurrence of a fault or another indication of a need for service and/or vehicle maintenance.

### SUMMARY

A method and associated device for automated maintenance scheduling for an autonomous vehicle is described, and includes monitoring, via a controller, a state of health (SOH) of an on-vehicle subsystem and monitoring an appointment log associated with a vehicle operator, wherein the appointment log includes a trip associated with a scheduled upcoming engagement for the vehicle operator. Upon detecting a change in the SOH of the on-vehicle subsystem, the method includes communicating, via a telematics controller, with a service center to determine a recommended maintenance action associated with the change in the SOH of the on-vehicle subsystem and to determine a proposed service appointment for the autonomous vehicle to effect the recommended maintenance action. The proposed service appointment is coordinated with the appointment log associated with the vehicle operator. The method then includes communicating with the vehicle operator to verify the proposed service appointment and communicating with the service center to schedule a service appointment based upon the proposed service appointment when verified by the vehicle operator. The appointment log is updated to include the service appointment.

An aspect of the disclosure includes the on-vehicle subsystem including one of a component, subsystem or system associated with an autonomic vehicle control system of the autonomous vehicle.

Another aspect of the disclosure includes communicating, via the telematics controller, with a ride service supplier to schedule alternative transportation for the vehicle operator based upon the proposed service appointment.

Another aspect of the disclosure includes the ride service supplier being one of a ride-sharing service supplier or a vehicle rental facility.

Another aspect of the disclosure includes determining a scheduled maintenance action for the autonomous vehicle and communicating with the service center to determine a proposed service appointment for the autonomous vehicle to effect the recommended maintenance action and the scheduled maintenance action for the autonomous vehicle.

Another aspect of the disclosure includes monitoring, via the controller, states of health (SOHs) of a plurality of on-vehicle subsystems, and determining a probability of completion of the trip based upon the SOHs of the plurality of on-vehicle subsystems and the expected operational distances and operating times associated with the trip.

Another aspect of the disclosure includes updating the appointment log to include the service appointment by rescheduling the trip.

Another aspect of the disclosure includes adjusting a route for the trip upon detecting the change in the SOH of the on-vehicle subsystem.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a vehicle that includes an autonomic vehicle control system and an associated vehicle health monitoring (VHM) system, in accordance with the disclosure;

FIG. 2 schematically illustrates an architecture in the form of discrete elements and information flow that can be advantageously employed for automated coordination, planning and maintenance scheduling of an autonomous vehicle, in accordance with the disclosure;

FIG. 3 schematically illustrates a flowchart for a pre-trip check routine that can be triggered to execute at the end of each trip for the operator to determine temporal information for scheduling a next desired trip by the operator, in accordance with the disclosure;

FIG. 4 schematically illustrates a flowchart for an embodiment of a service appointment routine that communicates with external vehicle service centers via a telematics controller to schedule service appointments for the vehicle, in accordance with the disclosure;

FIG. 5 schematically illustrates communication paths associated with an update schedule routine, which is supplied information from a service appointment routine and the VHM system, and communicates with a vehicle operator via operator interface device(s), in accordance with the disclosure; and

FIG. 6 schematically illustrates communication paths associated with an alternate commute routine, which is supplied information from a service appointment routine and an appointment log, and communicates via an operator interface device(s) with a vehicle operator and a vehicle rental facility, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

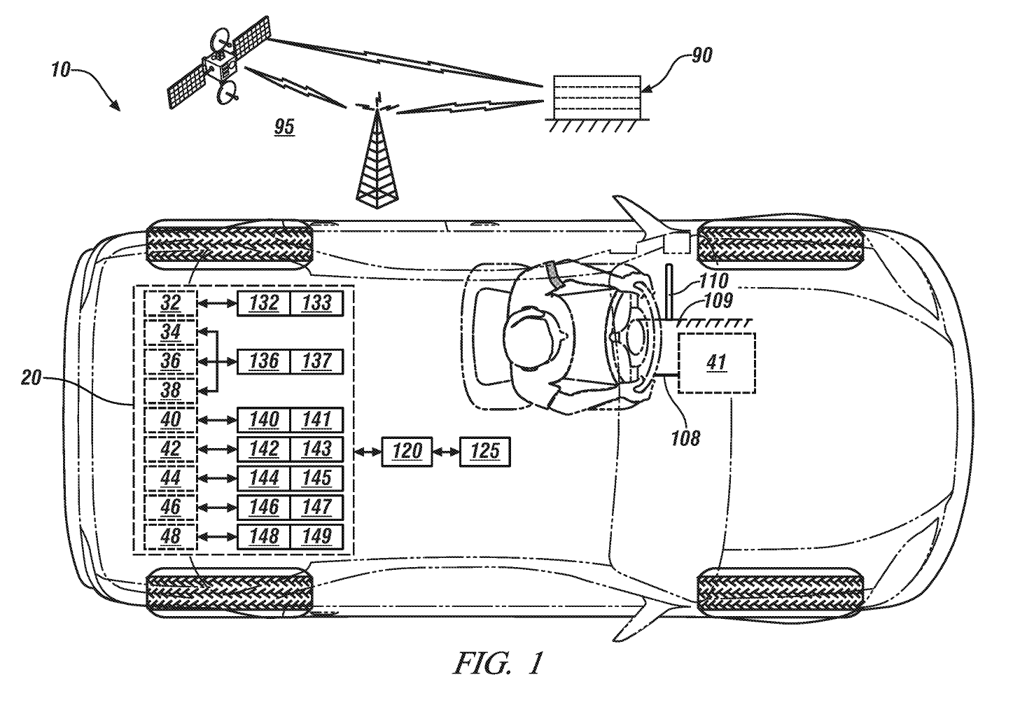

Referring to the drawings, wherein like reference numerals correspond to like or similar components throughout the several Figures, FIG. 1, consistent with embodiments disclosed herein, illustrates a vehicle 10 that includes an autonomic vehicle control system 20 and an associated vehicle health monitoring (VHM) system 120 that is illustrative of the concepts described herein. The vehicle 10 includes, in one embodiment, a four-wheel passenger vehicle with steerable front wheels and fixed rear wheels. The vehicle 10 may include, by way of non-limiting examples, a passenger vehicle, a light-duty or heavy-duty truck, a utility vehicle, an agricultural vehicle, an industrial/warehouse vehicle, or a recreational off-road vehicle.

As employed herein, the autonomic vehicle control system 20 includes an on-vehicle control system that is capable of providing a level of driving automation. The terms ‘driver’ and ‘operator’ describe the person responsible for directing operation of the vehicle, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle. Driving automation can include some level of automatic control or intervention related to simultaneous control of multiple vehicle functions, such as steering, acceleration, and/or braking, with the driver continuously having overall control of the vehicle. Driving automation can include simultaneous automatic control of vehicle driving functions, including steering, acceleration, and braking, wherein the driver cedes control of the vehicle for a period of time during a trip. Driving automation can include simultaneous automatic control of vehicle driving functions including steering, acceleration, and braking, wherein the driver cedes control of the vehicle for an entire trip. Driving automation includes hardware and controllers configured to monitor the driving environment under various driving modes to perform various driving tasks during dynamic operation. Driving automation can include, by way of non-limiting examples, cruise control, adaptive cruise control, lane-change warning, intervention and control, automatic parking, acceleration, braking, and the like.

The autonomic vehicle control system 20 preferably includes one or a plurality of vehicle systems and associated controllers that provide a level of driving automation. The vehicle systems, subsystems and controllers associated with the autonomic vehicle control system 20 are implemented to execute one or a plurality of operations associated with autonomous vehicle functions, including, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. The vehicle systems and associated controllers of the autonomic vehicle control system 20 can include, by way of non-limiting examples, a drivetrain 32 and drivetrain controller (PCM) 132; a steering system 34, a braking system 36 and a chassis system 38, which are controlled by a vehicle controller (VCM) 136; a vehicle spatial monitoring system 40 and spatial monitoring controller 140, a human-machine interface (HMI) system 42 and HMI controller 142; an HVAC system 44 and associated HVAC controller 144; operator controls 46 and an associated operator controller 146; and an infotainment system 48 and infotainment controller 148 and an associated VHM agent 149.

Each of the vehicle systems and associated controllers may further include one or more subsystems and associated controller. The subsystems and controllers are shown as discrete elements for ease of description. The foregoing classification of the subsystems is provided for purposes of describing one embodiment, and is illustrative. Other configurations may be considered within the scope of this disclosure. It should be appreciated that the functions described and performed by the discrete elements may be executed using one or more devices that may include algorithmic code, calibrations, hardware, application-specific integrated circuitry (ASIC), and/or off-board or cloud-based computing systems. Each of the aforementioned controllers includes a VHM agent that is in communication with the VHM system 120, and can be implemented and executed as algorithmic code, calibrations, hardware, application-specific integrated circuitry (ASIC), or other elements. Each of the VHM agents is configured to perform component and sub-system monitoring, feature extraction, data filtering and data recording for the associated controller. The data recording can include periodic and/or event-based data recording, single time-point data recording and/or consecutive time-point data recording for certain time duration, such as before and/or after the trigger of an event. Such data recording can be accomplished employing circular memory buffers or another suitable memory device.

The PCM 132 communicates with and is operatively connected to the drivetrain 32, and executes control routines to control operation of an engine and/or other torque machines, a transmission and a driveline, none of which are shown, to transmit tractive torque to the vehicle wheels in response to driver inputs, external conditions, and vehicle operating conditions. The PCM 132 is shown as a single controller, but can include a plurality of controller devices operative to control various powertrain actuators, including the engine, transmission, torque machines, wheel motors, and other elements of the drivetrain 32, none of which are shown. By way of a non-limiting example, the drivetrain 32 can include an internal combustion engine and transmission, with an associated engine controller and transmission controller. Furthermore, the internal combustion engine may include a plurality of discrete subsystems with individual controllers, including, e.g., an electronic throttle device and controller, fuel injectors and controller, etc. The drivetrain 32 may also be composed of an electrically-powered motor/generator with an associated power inverter module and inverter controller. The control routines of the PCM 132 may also include an adaptive cruise control system (ACC) that controls vehicle speed, acceleration and braking in response to driver inputs and/or autonomous vehicle control inputs. The PCM 132 also includes a PCM VHM agent 133.

The VCM 136 communicates with and is operatively connected to a plurality of vehicle operating systems and executes control routines to control operation thereof. The vehicle operating systems can include braking, stability control, and steering, which can be controlled by actuators associated with the braking system 36, the chassis system 38 and the steering system 34, respectively, which are controlled by the VCM 136. The VCM 136 is shown as a single controller, but can include a plurality of controller devices operative to monitor systems and control various vehicle actuators. The VCM 136 also includes a VCM VHM agent 137.

The steering system 34 is configured to control vehicle lateral motion. The steering system 34 can include an electrical power steering system (EPS) coupled with an active front steering system to augment or supplant operator input through a steering wheel 108 by controlling steering angle of the steerable wheels of the vehicle 10 during execution of an autonomic maneuver such as a lane change maneuver. An exemplary active front steering system permits primary steering operation by the vehicle driver including augmenting steering wheel angle control to achieve a desired steering angle and/or vehicle yaw angle. Alternatively or in addition, the active front steering system can provide complete autonomous control of the vehicle steering function. It is appreciated that the systems described herein are applicable with modifications to vehicle steering control systems such as electrical power steering, four/rear wheel steering systems, and direct yaw control systems that control traction of each wheel to generate a yaw motion.

The braking system 36 is configured to control vehicle braking, and includes wheel brake devices, e.g., disc-brake elements, calipers, master cylinders, and a braking actuator, e.g., a pedal. Wheel speed sensors monitor individual wheel speeds, and a braking controller can be mechanized to include anti-lock braking functionality

The chassis system 38 preferably includes a plurality of on-board sensing systems and devices for monitoring vehicle operation to determine vehicle motion states, and, in one embodiment, a plurality of devices for dynamically controlling a vehicle suspension. The vehicle motion states preferably include, e.g., vehicle speed, steering angle of the steerable front wheels, and yaw rate. The on-board sensing systems and devices include inertial sensors, such as rate gyros and accelerometers. The chassis system 38 estimates the vehicle motion states, such as longitudinal speed, yaw-rate and lateral speed, and estimates lateral offset and heading angle of the vehicle 10. The measured yaw rate is combined with steering angle measurements to estimate the vehicle state of lateral speed. The longitudinal speed may be determined based upon signal inputs from wheel speed sensors arranged to monitor each of the front wheels and rear wheels. Signals associated with the vehicle motion states can be communicated to and monitored by other vehicle control systems for vehicle control and operation.

The vehicle spatial monitoring system 40 and spatial monitoring controller 140 can include a controller that communicates with sensing devices to monitor and generate digital representations of remote objects proximate to the vehicle 10. The spatial monitoring controller 140 also includes a spatial monitoring VHM agent 141. The spatial monitoring controller 140 can determine a linear range, relative speed, and trajectory of each proximate remote object, and includes front corner sensors, rear corner sensors, rear side sensors, side sensors, a front radar sensor, and a camera in one embodiment, although the disclosure is not so limited. Placement of the aforementioned sensors permits the spatial monitoring controller 140 to monitor traffic flow including proximate object vehicles and other objects around the vehicle 10. Data generated by the spatial monitoring controller 140 may be employed by a lane mark detection processor (not shown) to estimate the roadway. The sensing devices of the vehicle spatial monitoring system 40 can further include object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other camera/video image processors which utilize digital photographic methods to ‘view’ forward objects including one or more object vehicle(s). Such sensing systems are employed for detecting and locating objects in automotive applications and are useable with systems including, e.g., adaptive cruise control, autonomous braking, autonomous steering and side-object detection.

The sensing devices associated with the vehicle spatial monitoring system 40 are preferably positioned within the vehicle 10 in relatively unobstructed positions. It is also appreciated that each of these sensors provides an estimate of actual location or condition of an object, wherein said estimate includes an estimated position and standard deviation. As such, sensory detection and measurement of object locations and conditions are typically referred to as ‘estimates.’ It is further appreciated that the characteristics of these sensors are complementary, in that some are more reliable in estimating certain parameters than others. Sensors can have different operating ranges and angular coverages capable of estimating different parameters within their operating ranges. For example, radar sensors can usually estimate range, range rate and azimuth location of an object, but are not normally robust in estimating the extent of a detected object. A camera with vision processor is more robust in estimating a shape and azimuth position of the object, but is less efficient at estimating the range and range rate of an object. Scanning type lidar sensors perform efficiently and accurately with respect to estimating range, and azimuth position, but typically cannot estimate range rate, and are therefore not as accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, some sensors present parametric variances during operation, although overlapping coverage areas of the sensors create opportunities for sensor data fusion.

The HVAC system 44 is disposed to manage the ambient environment of the passenger compartment, including, e.g., temperature, humidity, air quality and the like, in response to operator commands that are communicated to the HVAC controller 144, which controls operation thereof. The HVAC controller 144 also includes an HVAC VHM agent 145.

The operator controls 46 can be included in the passenger compartment of the vehicle 10 and may include, by way of non-limiting examples, a steering wheel 108, an accelerator pedal, a brake pedal (not shown) and an operator input device 110. The operator controls 46 and associated operator controller 146 enable a vehicle operator to interact with and direct operation of the vehicle 10 in functioning to provide passenger transportation. The operator controller 146 also includes an operator controller VHM agent 147.

The steering wheel 108 can be mounted on a steering column 109 with the input device 110 mechanically mounted on the steering column 109 and configured to communicate with the operator controller 146. Alternatively, the input device 110 can be mechanically mounted proximate to the steering column 109 in a location that is convenient to the vehicle operator. The input device 110, shown herein as a stalk projecting from column 109, can include an interface device by which the vehicle operator may command vehicle operation in one or more autonomic control modes, e.g., by commanding activation of element(s) of the autonomic vehicle control system 20. The mechanization of the input device 110 is illustrative. The input device 110 may be mechanized in one or more of a plurality of devices, or may be in the form of a controller that is voice-activated, or may be another suitable system. The input device 110 preferably has control features and a location that is used by present turn-signal activation systems. Alternatively, other input devices, such as levers, switches, buttons, and voice recognition input devices can be used in place of or in addition to the input device 110.

The HMI system 42 provides for human/machine interaction, for purposes of directing operation of an infotainment system, a GPS system, a navigation system, a remotely located service center and the like, and includes an HMI controller 142. The HMI controller 142 monitors operator requests and provides information to the operator including status of vehicle systems, service and maintenance information. The HMI controller 142 can also include a global positioning/navigation system. The HMI controller 142 communicates with and/or controls operation of a plurality of in-vehicle operator interface device(s) 41, wherein the in-vehicle operator interface device(s) 41 are capable of transmitting a message associated with operation of one of the autonomic vehicle control systems. The HMI controller 142 preferably also communicates with one or more devices that monitor biometric data associated with the vehicle operator, including, e.g., eye gaze location, posture, and head position tracking, among others. The HMI controller 142 is depicted as a unitary device for ease of description, but may be configured as a plurality of controllers and associated sensing devices in an embodiment of the system described herein. The HMI controller 142 also includes an HMI VHM agent 143. The in-vehicle operator interface device(s) 41 can include devices that are capable of transmitting a message urging operator action, and can include an electronic visual display module, e.g., a liquid crystal display (LCD) device, a heads-up display (HUD), an audio feedback device, a wearable device and a haptic seat. The in-vehicle operator interface device(s) 41 that are capable of urging operator action are preferably controlled by or through the HMI controller 142. The HUD may project information that is reflected onto an interior side of a windshield of the vehicle, in the field of view of the operator, including transmitting a confidence level associated with operating one of the autonomic vehicle control systems. The HUD may also provide augmented reality information, such as lane location, vehicle path, directional and/or navigational information, and the like. HUD and related systems are known to those skilled in the art.

In one embodiment, the vehicle 10 is configured to communicate with an off-board communication network 95 via a telematics controller 125. This includes communicating between a controller associated with an intelligent highway system and the vehicle 10. An intelligent highway system can be configured to monitor locations, speeds and trajectories of a plurality of vehicles, with such information employed to facilitate control of one or a plurality of similarly-situated vehicles. This can include communicating geographic location, forward velocity and acceleration rate of one or more vehicles in relation to the vehicle 10. In one embodiment, the vehicle 10 is configured to communicate with the remote server 90 via the communication network 95.

The VHM system 120 includes a plurality of controllers, routines and calibrations that are executable to monitor, prognosticate and diagnose operation of the components, subsystems and systems of the autonomic vehicle control system 20. The VHM system 120 is configured to autonomously monitor a state of health (SOH) of the components, subsystems and systems that perform or monitor one or more functions related to autonomous vehicle operation. The VHM system 120 includes a controller architecture that is configured with multilayer hierarchical VHM data processing, collection, and storage employing the plurality of VHM agents. This configuration can serve to reduce data processing complexity, data collection and data storage costs. The VHM system 120 can provide a centralized system monitoring and a distributed system monitoring arrangement with data collection via a VHM master controller and the plurality of VHM agents to provide a rapid response time and an integrated vehicle/system level coverage. The VHM system 120 is configured to communicate with in-vehicle controllers to perform vehicle system diagnosis and prognosis based on onboard data and inputs from the VHM agents, and dynamically detect anomalies, e.g., intermittent faults, and can communicate diagnosis and prognosis results to a fault mitigation controller. The VHM system 120 can also include a redundant VHM master controller to verify integrity of VHM information.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. The term ‘model’ refers to a processor-based or processor-executable code and associated calibration that simulates a physical existence of a device or a physical process. The terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrate”, and related terms refer to a result or a process that compares an actual or standard measurement associated with a device with a perceived or observed measurement or a commanded position. A calibration as described herein can be reduced to a storable parametric table, a plurality of executable equations or another suitable form.

Communication between controllers, and communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

The terms “prognosis”, “prognostics”, and related terms are associated with data monitoring and algorithms and evaluations that render an advance indication of a likely future event associated with a component, a subsystem, or a system. Prognostics can include classifications that include a first state that indicates that the component, subsystem, or system is operating in accordance with its specification (“Green” or “G”), a second state that indicates deterioration in the operation of the component, subsystem, or system (“Yellow” or “Y”), and a third state that indicates a fault in the operation of the component, subsystem, or system (“Red” or “R”). The terms “diagnostics”, “diagnosis” and related terms are associated with data monitoring and algorithms and evaluations that render an indication of presence or absence of a specific fault with a component, subsystem or system. The term “mitigation” and related terms are associated with operations, actions or control routine that operate to lessen the effect of a fault in a component, subsystem or system.

The telematics controller 125 includes a wireless telematics communication system capable of extra-vehicle communications, including communicating with a communication network system 95 having wireless and wired communication capabilities. The telematics controller 125 is capable of extra-vehicle communications that includes short-range vehicle-to-vehicle (V2V) communication. Alternatively or in addition, the telematics controller 125 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics controller 125, and the handheld device executes the extra-vehicle communication, including communicating with a remote server 90 via the communication network 95. Alternatively or in addition, the telematics controller 125 executes the extra-vehicle communication directly by communicating with the off-board controller 90 via the communication network 95.

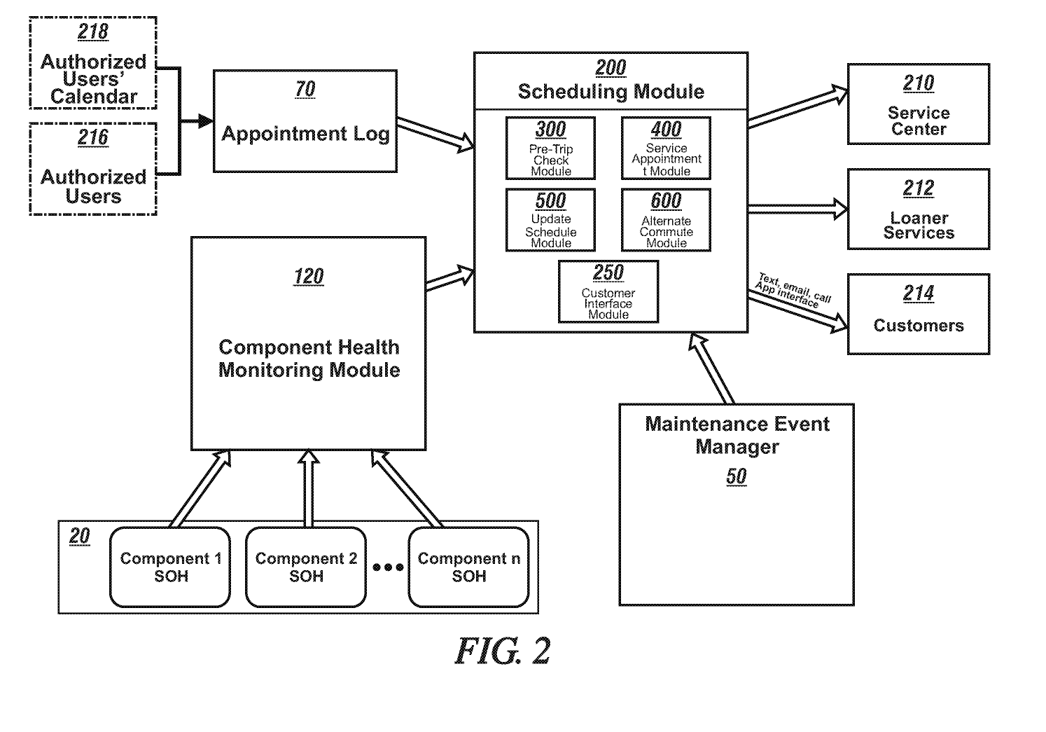

FIG. 2 schematically shows an architecture in the form of discrete elements and information flow that can be advantageously employed for automated coordination, planning and maintenance scheduling of an autonomous vehicle, e.g., the autonomous vehicle 10 that is described with reference to FIG. 1. The discrete elements include the VHM system 120 for the autonomic vehicle control system 20 of the autonomous vehicle 10, a maintenance event manager 50, an appointment log 70 and a scheduling controller 200. The VHM system 120 for the autonomic vehicle control system 20 of the autonomous vehicle 10, the maintenance event manager 50, the appointment log 70 and the scheduling controller 200 are implemented as routines and associated memory locations that are stored and executed in controllers that are on-board the autonomous vehicle 10 in one embodiment.

As previously described, the VHM system 120 is disposed to monitor, prognosticate and diagnose operation of the components, subsystems and systems of the autonomic vehicle control system 20. Such information is communicated to the scheduling controller 200 either periodically, in response to an event, or in response to a request from the scheduling controller 200.

The maintenance event manager 50 is a controller-executed routine and associated memory that maintains vehicle-specific maintenance and service log, and an associated maintenance schedule. The maintenance schedule is derived from manufacturer-recommended maintenance and service intervals, such as may include engine, transmission other driveline fluid changes, lubrication schedules, tire rotations, timing belt changes, etc. The maintenance event manager 50 monitors the vehicle odometer, engine run-time, and other factors, and generates information that indicates an impending need for recommended maintenance or scheduled maintenance.

The term “recommended maintenance” indicates a special-purpose maintenance event that is triggered in response to diagnostic and/or prognostic routines associated with the VHM system 120 that indicates either a fault or an impending fault in one of the components, subsystems or systems. The term “scheduled maintenance” indicates a maintenance event that is derived from the manufacturer-recommended maintenance and service intervals. Such information is communicated to the scheduling controller 200 either periodically or in response to a request from the scheduling controller 200.

The appointment log 70 is configured to monitor upcoming engagements from vehicle scheduling calendars 218 of one or more authorized vehicle operators 216. In one embodiment, the upcoming engagements can be input by the operator(s) via a smart-phone app. The appointment log 70 captures and maintains a record of the upcoming engagements and associated trips in memory. Trips associated with upcoming engagements can include, by way of example, daily commuting trips, scheduled trips to a medical facility, periodic trips to a religious facility, vacation trips, etc.

The scheduling controller 200 includes a pre-trip check routine 300, a service appointment routine 400, an update schedule routine 500, an alternate commute routine 600, and is disposed to communicate to the vehicle operator via an operator interface routine 250. The scheduling routine 200 monitors inputs from the VHM system 120 for the autonomic vehicle control system 20 of the autonomous vehicle 10, the maintenance event manager 50, the appointment log 70 and the scheduling routine 200, and generates communications to a service center routine 210, a ride service supplier 212 and/or the operator(s) 214 via the telematics controller 125. The ride service supplier 212 may be a vehicle rental facility in one embodiment, or a ride-sharing service supplier, or a limousine service, a taxi service, etc.

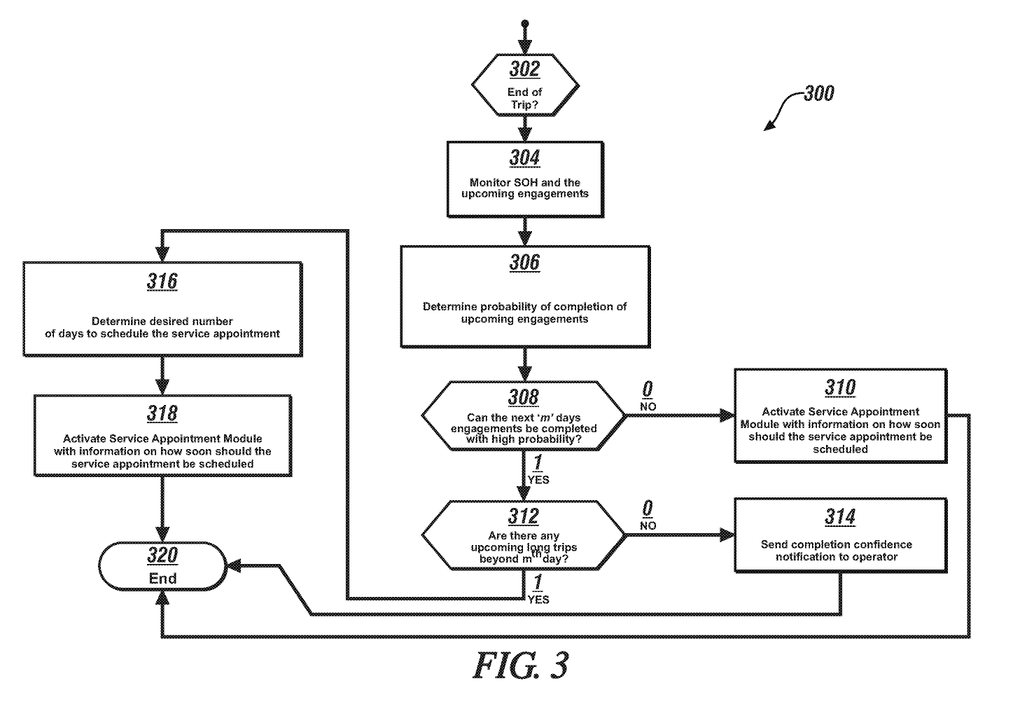

The pre-trip check routine 300 can be triggered to execute at the end of each trip for the operator to determine temporal information for scheduling a next desired trip by the operator and determining and scheduling a service appointment to effect a recommended maintenance action. The pre-trip check routine 300 ensures vehicle availability for the next desired trip, and is executed as a control routine and an associated database in a memory device in one of the vehicle controllers. FIG. 3 schematically shows an embodiment of the pre-trip check routine 300. Table 1 is provided as a key wherein the numerically labeled blocks and the corresponding functions are set forth as follows, corresponding to the pre-trip check routine 300. The teachings may be described herein in terms of functional and/or logical block components and/or various processing steps. It should be realized that such block components may be composed of hardware, software, and/or firmware components that have been configured to perform the specified functions.

TABLE 1

| BLOCK | BLOCK CONTENTS |
|---|---|
| 302 | End of trip? |
| 304 | Monitor SOH information, upcoming |
| | engagements |
| 306 | Determine probability of completion of |
| | upcoming engagements |
| 308 | Can next ‘m’ days of engagements be |
| | completed with high probability? |
| 310 | Activate service appointment routine - |
| | Determine how soon service appointment |
| | needs to be scheduled |
| 312 | Are there upcoming extended trips beyond |
| | the mth day? |
| 314 | Send completion confidence to operator |
| 316 | Determine desired number of days to |
| | schedule service appointment |
| 318 | Activate service appointment routine - How |
| | soon should service appointment be |
| | scheduled |
| 320 | End |

Execution of the pre-trip check routine 300 may proceed as follows. The steps of the pre-trip check routine 300 may be executed in a suitable order, and are not limited to the order described with reference to FIG. 3. The pre-trip check routine 300 executes upon detection of an end-of-trip event in one embodiment (302)(1), and includes monitoring SOH information associated with the components, subsystems and systems of the autonomic vehicle control system 20 as provided by the VHM system 120, and monitoring upcoming engagements as provided by the appointment log 70 (304).

The pre-trip check routine 300 evaluates the probability of completion of the scheduled upcoming engagements for each of the ensuing days or weeks, taking into account the SOH information and the expected operational distances and operating times associated with the scheduled upcoming engagements (306). The evaluation includes evaluating whether the next ‘m’ days of engagements be completed with a high probability (308).

When the next ‘m’ days of engagements cannot be completed with a high probability (308)(0), the service appointment routine 400 is activated with information that indicates when a service appointment for the vehicle needs to be scheduled (310), and this iteration ends (320). When the next ‘m’ days of engagements can be completed with a high probability (308)(1), the pre-trip check routine 300 evaluates whether there are upcoming extended trips beyond the mth day (312).

When there are no upcoming extended trips beyond the mth day (312)(0), the operator is notified, via the telematics controller 125, that there is a high confidence that the next ‘m’ days of engagements can be completed with a high probability (314), and this iteration ends (320). When there is an upcoming extended trip beyond the mth day (312)(1), the pre-trip check routine 300 determines a desired time period, e.g., a number of days to schedule a service appointment in view of the present vehicle state as indicated by the SOH (316). The service appointment routine 400 is activated with information that indicates when the service appointment for the vehicle needs to be scheduled (318), and this iteration ends (320).

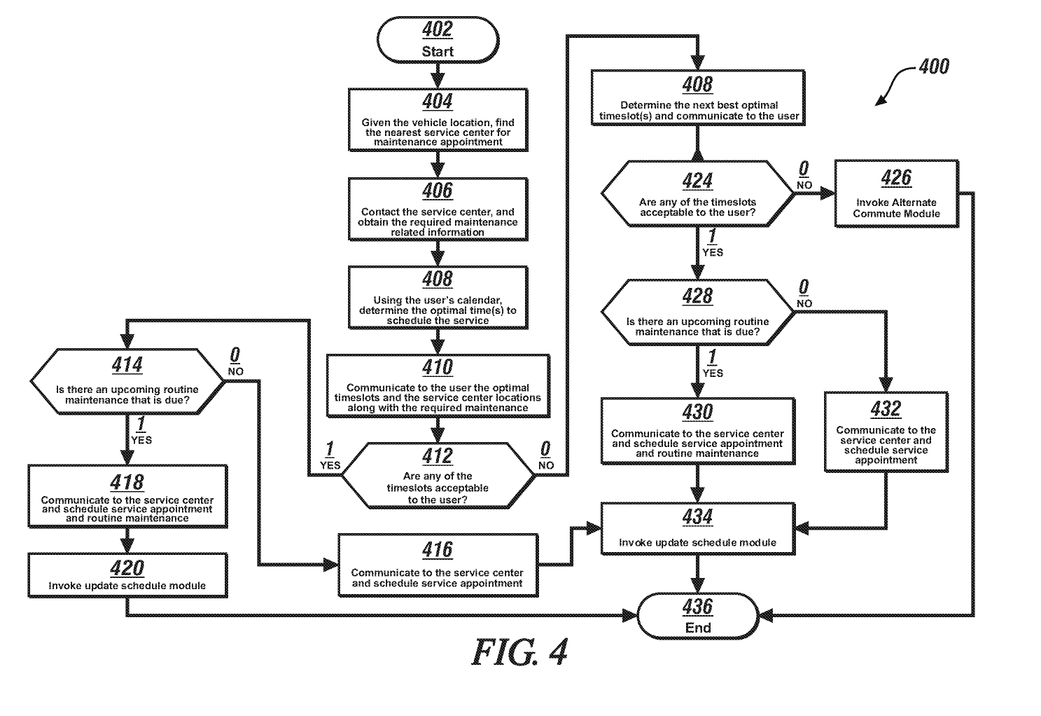

FIG. 4 schematically shows an embodiment of the service appointment routine 400, which communicates with external vehicle service centers via the telematics controller 125 to schedule service appointments for the vehicle 10. The service appointment routine 400 is executed as a control routine and an associated database in a memory device in one of the vehicle controllers. Table 2 is provided as a key wherein the numerically labeled blocks and the corresponding functions are set forth as follows, corresponding to the service appointment routine 400. The teachings may be described herein in terms of functional and/or logical block components and/or various processing steps. It should be realized that such block components may be composed of hardware, software, and/or firmware components that have been configured to perform the specified functions.

TABLE 2

| BLOCK | BLOCK CONTENTS |
|---|---|
| 402 | Start iteration |
| 404 | Find location(s) of nearest service center(s) |
| 406 | Contact service center(s) and determine |
| | maintenance or service action |
| 408 | Determine best time/date slot(s) to schedule |
| | vehicle service based upon operator's |
| | calendar |
| 410 | Communicate best time/date slot(s), |
| | location(s) and recommended maintenance |
| | to operator |
| 412 | Are best time/date slot(s) acceptable to |
| | operator? |
| 414 | Does vehicle need routine maintenance? |
| 416 | Communicate with service center to |
| | schedule service appointment |
| 418 | Communicate with service center to |
| | schedule service appointment and routine |
| | maintenance |
| 420 | Invoke update schedule routine 500 |
| 422 | Determine alternative time/date slot(s) and |
| | communicate to operator |
| 424 | Are alternative time/date slot(s) acceptable? |
| 426 | Invoke alternate commute routine 600 |
| 428 | Does vehicle need routine maintenance? |
| 430 | Communicate with service center to |
| | schedule service appointment and routine |
| | maintenance |
| 432 | Communicate with service center to |
| | schedule service appointment |
| 434 | Invoke update schedule routine 500 |
| 436 | End iteration |

The service appointment routine 400 is supplied information from the maintenance event manager 50, the appointment log 70 and the pre-trip check routine 300, and communicates with one or more remotely located service centers 210 and with the vehicle operator 214 via the operator interface routine 250 and the telematics controller 125. Each iteration (402), service appointment routine 400 locates the geographically nearest service center(s) (404) and communicates with one or more of them to determine information related to recommended maintenance or service actions (406) and also determine a best time/date slot to schedule vehicle service employing information provided by the operator's appointment log 70 (408).

The best time/date slot(s), service center location(s) and recommended maintenance or service actions is communicated to the operator (410), and the operator is queried to determine if one of the time/date slot(s) is acceptable to the operator (412).

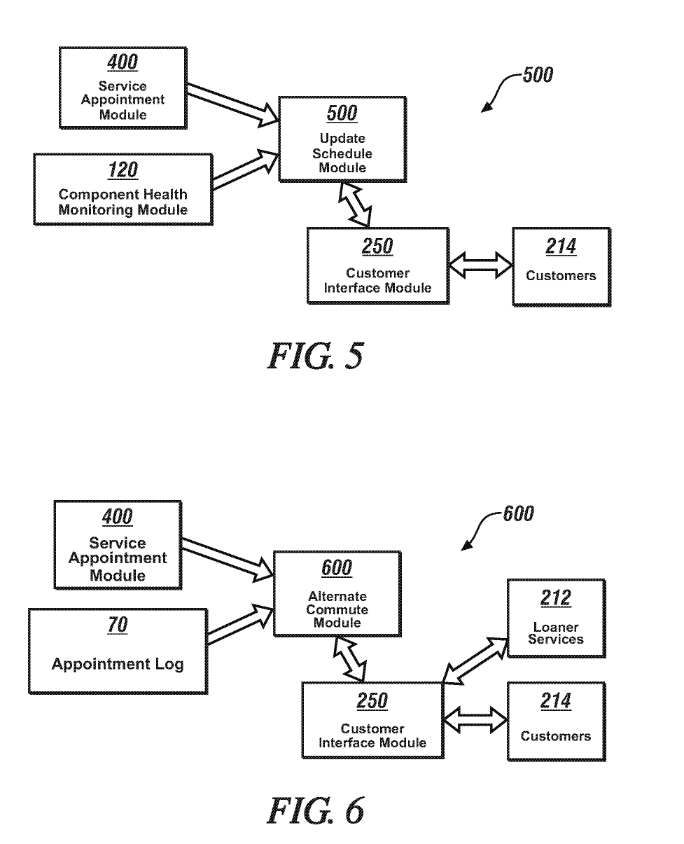

When one of the time/date slot(s) is acceptable to the operator (412)(1), the service appointment routine 400 determines if the vehicle 10 also needs routine maintenance, such as an oil change (414). If there is a need for routine maintenance (414)(1), the vehicle 10 communicates with the service center 210 to schedule the service appointment to effect the recommended maintenance and the routine maintenance (418) and invokes the update schedule routine 500 (420), and this iteration ends (436). If there is no need for routine maintenance (414)(0), the vehicle 10 communicates with the service center 210 to schedule the service appointment (416) and invokes the update schedule routine 500 (434), and this iteration ends (436). The update schedule routine 500 is described with reference to FIG. 5.

When the best time/date slot(s) is not acceptable to the operator (412)(0), the service appointment routine 400 determines an alternative time/date slot(s), which is communicated to the operator with the service center location(s) and recommended maintenance or service actions (422), and the operator is queried to determine whether the alternative time/date slot(s) is acceptable to the operator (424). When the alternative time/date slot(s) is not acceptable to the operator (424)(0), the alternate commute routine 600 is invoked (426) and this iteration ends (436). The alternate commute routine 600 is described with reference to FIG. 6.

When the alternative time/date slot(s) is acceptable to the operator (424)(1), the service appointment routine 400 determines whether the vehicle 10 also needs routine maintenance, such as an oil change (428). If there is a need for routine maintenance (428)(1), the vehicle 10 communicates with the service center 210 to schedule the service appointment to effect the recommended maintenance and the routine maintenance (430) and invokes the update schedule routine 500 (434), and this iteration ends (436). If there is no need for routine maintenance (428)(0), the vehicle 10 communicates with the service center 210 to schedule the service appointment and routine maintenance (432) and invokes the update schedule routine 500 (434), and this iteration ends (436).

FIG. 5 schematically shows communication paths associated with the update schedule routine 500. The update schedule routine 500 is supplied information from the service appointment routine 400 and the VHM system 120, and communicates with the vehicle operator 214 via the operator interface routine 250 and the telematics controller 125. The update schedule routine 500 determines desired conditions for operating the vehicle 10 based upon the SOH as indicated by the VHM system 120, including an indication of the severity of the need for the recommended maintenance and the time remaining until the scheduled appointment. The update schedule routine 500 can also determine whether the operating conditions warrant a change to the operator's calendar, and communicates the suggested calendar changes to the operator, and also make updates to the calendar, and communicate the changes to family, friends, other affected parties, such as travel partners, alternative transportation appointments, airline appointments, etc. The update schedule routine 500 can also include selecting an alternate route for an impending trip to reduce vehicle stress. Such alternate route selection may include trip routing that includes avoiding or minimizing vehicle operation on a high-speed limited access highway to avoid high-speed operation, by way of a non-limiting example.

FIG. 6 schematically shows communication paths associated with the alternate commute routine 600. The alternate commute routine 600 is supplied information from the service appointment routine 400 and the appointment log 70, and communicates with the vehicle operator 214 and the ride service supplier 212 via the operator interface routine 250 and the telematics controller 125. The alternate commute module 600 gathers available rental or other transportation options from the one or a plurality of the ride service suppliers 212, taking into account the operator calendar in view of upcoming engagements that are captured in the appointment log 70. The alternate commute module 600 communicates available options to the operator based on their preferences, arranges for the loaner vehicles or other alternative transportation to be available at the operator's location.

The method, system and architecture described herein can be advantageously employed for automated coordination, planning and scheduling of maintenance for an autonomous vehicle employing vehicle health data. The intelligent vehicle coordination, planning and maintenance scheduling system can determine whether or not the vehicle can fulfill the upcoming engagements based upon SOH, and if not, can schedule maintenance/service appointments. Furthermore, the operator can be provided with alternate transportation arrangements, adjust travel plans and coordination of travel plans, and interact with the operator via phone, text, email, app interface, and/or another suitable communication medium. When faced with vehicle SOH issues, scheduled maintenance efforts can be accelerated in time. Changes affecting an operator's calendar can trigger warnings about what other activities might be affected.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for automated maintenance scheduling for an autonomous vehicle, comprising:
monitoring, via a controller, a state of health (SOH) of an on-vehicle component;
monitoring an appointment log associated with a vehicle operator, wherein the appointment log includes a trip associated with a scheduled upcoming engagement for the vehicle operator;
upon detecting a change in the SOH of the on-vehicle component:
communicating, via an on-board telematics controller, with a service center to determine a recommended maintenance action associated with the change in the SOH of the on-vehicle component,
communicating, via the telematics controller, with the service center to determine a proposed service appointment for the autonomous vehicle to effect the recommended maintenance action, wherein the proposed service appointment is coordinated with the appointment log associated with the vehicle operator;
communicating, via the telematics controller, with the vehicle operator to verify the proposed service appointment;
communicating, via the telematics controller, with the service center to schedule a service appointment based upon the proposed service appointment when verified by the vehicle operator; and
updating the appointment log to include the service appointment.

2. The method of claim 1, wherein the on-vehicle component is associated with an autonomic vehicle control system of the autonomous vehicle.

3. The method of claim 1, further comprising communicating, via the telematics controller, with a ride service supplier to schedule alternative transportation for the vehicle operator based upon the proposed service appointment.

4. The method of claim 3, wherein the ride service supplier comprises one of a ride-sharing service supplier or a vehicle rental facility.

5. The method of claim 1, further comprising:
determining a scheduled maintenance action for the autonomous vehicle; and
communicating, via the telematics controller, with the service center to determine a proposed service appointment for the autonomous vehicle to effect the recommended maintenance action and the scheduled maintenance action for the autonomous vehicle.

6. The method of claim 1, further comprising:
monitoring, via the controller, states of health (SOHs) of a plurality of on-vehicle components; and
determining a probability of completion of the trip based upon the SOHs of the plurality of on-vehicle components and the expected operational distances and operating times associated with the trip.

7. The method of claim 1, wherein updating the appointment log to include the service appointment further comprises rescheduling the trip.

8. The method of claim 1, further comprising adjusting a route for the trip upon detecting the change in the SOH of the on-vehicle component.

9. A method for automated maintenance scheduling for an autonomous vehicle, comprising:
monitoring, via a controller, a state of health (SOH) of a component that is employed in an autonomic vehicle control system of the autonomous vehicle;
upon detecting a change in the SOH of the component affecting performance of the autonomic vehicle control system:
communicating, via an on-board telematics controller, with a service center to determine a recommended maintenance action, monitoring an appointment log associated with a vehicle operator;
communicating, via the telematics controller, with the service center to determine a proposed service appointment for the autonomous vehicle to effect the recommended maintenance action, wherein the proposed service appointment is coordinated with the appointment log;
communicating, via the telematics controller, with the vehicle operator to verify the proposed service appointment;
communicating, via the telematics controller, with the service center to schedule a service appointment based upon the proposed service appointment when verified by the vehicle operator; and
updating the appointment log to include the service appointment.

10. The method of claim 9, further comprising communicating, via the telematics controller, with a ride service supplier to schedule alternative transportation for the vehicle operator based upon the proposed service appointment.

11. The method of claim 10, wherein the ride service supplier comprises one of a ride-sharing service supplier or a vehicle rental facility.

12. The method of claim 9, further comprising:
determining a scheduled maintenance action for the autonomous vehicle; and
communicating, via the telematics controller, with the service center to determine a proposed service appointment for the autonomous vehicle to effect the recommended maintenance action and the scheduled maintenance action for the autonomous vehicle.

13. The method of claim 9, further comprising:
monitoring, via the controller, states of health (SOHs) of a plurality of on-vehicle components; and
determining a probability of completion of the trip based upon the SOHs of the plurality of on-vehicle components and the expected operational distances and operating times associated with the trip.

14. The method of claim 9, wherein updating the appointment log to include the service appointment further comprises rescheduling the trip.

15. The method of claim 9, further comprising adjusting a route for the trip upon detecting the change in the SOH of the on-vehicle component.

16. An autonomous vehicle, comprising:
an autonomic vehicle control system;
a first controller in communication with the autonomous vehicle control system and including a control routine that is disposed to monitor a state of health (SOH) of a component of the autonomous vehicle control system;
a second controller including a control routine that is disposed to monitor an appointment log of a vehicle operator;
a third controller including a control routine that is disposed to manage a maintenance event;
a scheduling controller including a pre-trip check routine, a service appointment routine, an update schedule routine, an alternate commute routine and an operator interface routine; and
a telematics controller;
wherein:
the first, second and the third controllers are in communication with the scheduling controller;
wherein the scheduling controller is in communication with the telematics controller;
wherein the first controller is disposed to monitor the SOH of the component and detect a change in the SOH of the component affecting performance of the autonomic vehicle control system and communicate the change in the SOH of the component to the scheduling controller;
wherein the scheduling controller is disposed to communicate with a service center via the telematics controller to determine a recommended maintenance action based upon the change in the SOH of the component,
wherein the scheduling controller is disposed to communicate with the service center via the telematics controller to determine a proposed service appointment for the autonomous vehicle to effect the recommended maintenance action;
wherein the scheduling controller is disposed to communicate with the second controller to coordinate the proposed service appointment with the appointment log;
wherein the scheduling controller is disposed to communicate, via the telematics controller, with the vehicle operator to verify the proposed service appointment;
wherein the scheduling controller is disposed to communicate with the service center via the telematics controller to schedule a service appointment based upon the proposed service appointment when verified by the vehicle operator; and
wherein the second controller is disposed to update the appointment log to include the service appointment.
